(19) United States
(12) Patent Application Publication
(10) Pub. No.: US 2015/0081816 A1
(43) Pub. Date: Mar. 19, 2015

(54) ELECTRONIC MESSAGE MANAGEMENT SYSTEM

(71) Applicant: NOT NOW PTY LTD, Subiaco, W.A. (AU)

(72) Inventor: James Trevelyan, Dalkeith (AU)

(21) Appl. No.: 14/390,382

(22) PCT Filed: Mar. 27, 2013
(86) PCT No.: PCT/AU2013/000317

§ 371 Date: Oct. 2, 2014

(30) Foreign Application Priority Data
Apr. 4, 2012 (AU) 2012901610

(51) Int. Cl. H04L 12/58

(52) U.S. Cl. CPC H04L 51/18
USPC 709/206

(57) ABSTRACT

An electronic message management system is disclosed that comprises an electronic message server arranged to receive electronic messages addressed to a recipient user associated with the electronic message server, and to cause electronic messages to be sent from the electronic message server to an electronic message client associated with the user and arranged to display messages indicative of the electronic messages, and a storage device arranged to store delivery rules. The system is arranged to store electronic messages until the electronic messages are sent to an electronic message client. Each recipient user associated with the system has at least one associated delivery rule defining when electronic messages received by the message server are made available for sending by the message server to the message client associated with the recipient user. The system is arranged to apply the delivery rules to electronic messages received by the message server so as to control when the received electronic messages are made available for sending by the message server to the message client associated with the recipient user. A corresponding method is also disclosed.

### FIELD OF THE INVENTION

The invention relates to an electronic message management system, and in particular to an email management system for managing delivery of email to a user and to a method of managing email.

### BACKGROUND OF THE INVENTION

An email or text message is transmitted in the form of a sequence of alphanumeric characters. The character sequence has several distinct sections, each preceded by a recognisable sequence of characters known as a character key.

An example email message structure 10 is shown in FIG. 1. The message structure 10 includes an envelope section 12 that specifies the actual email address of the sender of the message and the actual email address(es) of the intended recipient(s), and an email header section 14 that contains information for display about the message sender and recipients, the subject of the message, the time and date when the message was sent, and an identification number.

As an email message is generally received by different software processes as it travels from the sender to the recipient(s), the software processes may add additional information to the email header 14 to record that the message has been processed by the software processes. This enables a person to understand the way that the email message has been processed. For example, in the event of unusual performance of an email system, examination of the message email header may reveal useful information as to the causes of the problem.

Apart from the subject text of the email message, the email header does not contain any of the human readable content of the email message. Instead, the content follows the email header section 14 in a message body section 16 separated from the header section 14 by a blank line 18.

An email address consists of a first character string associated with the owner of the email address, an ampersand sign “@”, and a second character string denoting the address of a mail server for which the email owner is an authorised user. The mail server address is usually a character string of an enterprise with which the email owner is associated, followed by one or more character strings separated by dots that define particular ‘domains’; that is, communities of common interest on the Internet computer network. For example, bill.chen@rightfinders.com.au would commonly be recognised as the email address belonging to Bill Chen working for the enterprise “Right Finders”. The domain ‘.com.au’ is commonly associated with commercial enterprises in Australia.

There are several components that together facilitate email communication using the Internet. These components typically consist of software processes (also known as applications) running on different computers. More than one process may run on one computer in some instances.

An email client is generally a process that is implemented by a user computing device and serves as an intermediary between an email user and an email management system. The email client receives email from a mail server and, under control of the user, displays the message associated with the email on the user's computing device. The user can also use the email client to compose a new email message and instigate transmission of the email message to one or more recipients. The email client, in this instance, typically transmits the email message to the mail server, and the mail server subsequently transmits the message to one or more recipient email clients.

Many different email clients exist and most users have particular preferences for a particular email client because of familiarity with the email client. Once the user's preference is established, there is great reluctance to adopt a new email service or a new email client, because it takes time for the user to become accustomed to the particular features of the email client.

An email client may be implemented on the user's computing device, or may be implemented remotely and access facilitated through a web browser.

A mail server is part of an email management system and generally comprises several components.

Although different mail servers are designed with different components, currently used email servers all comply with an agreed international standard (RFC 5322, Internet Engineering Task Force, www.ietf.org) that defines the formats of the required text strings making up the content of an email header and the actions that mail servers and mail clients should take in response to detecting particular text strings in an email message. The same standards also define the communication protocol that mail servers use to send messages between each other.

Two common mail servers are ‘Postfix’ and ‘Microsoft Exchange’. The former is an application that runs under UNIX operating system (or its equivalents such as Linux) and is freely available public domain software. The latter is a proprietary software application that runs under Windows Server operating system. Microsoft Exchange is a mail server that is widely used by small, medium and large enterprises.

A mail server generally runs continuously and is arranged to receive email messages transmitted across a computer network such as the Internet from other mail servers or from email clients.

An incoming email message received by a mail server passes through several processing steps before being stored and made available to an email client.

Although the above mail servers operate in slightly different ways, their basic operation is essentially the same.

A conventional mail server 20 is shown conceptually in FIG. 2.

The mail server 20 includes a format checker 22, typically implemented by a software process, that checks whether the incoming data originates from a valid mail server, and that the data transmitted as an incoming email message is correctly formatted as an email message. If the email format is incorrect, the mail server 20 generates an automatic reply message to indicate that the message was received but could not be handled because of incorrect formatting.

The mail server 20 also includes a recipient checker 24, typically implemented by a software process, that checks the list of actual recipient email address(es) contained in the envelope 12 against recognised email addresses stored in an address database 29 to determine whether the recipient address(es) are recognised as authorised users associated with the mail server 20.

If the mail server 20 detects that the message has been addressed to a particular user who is not an authorised user, then the mail server 20 generates an automatic reply to the sender to indicate that the message cannot be delivered because the recipient is not recognised.

The mail server 20 connects through a mail transport agent access port 35 to a filter 26, typically implemented by a software process, that scans the incoming email message to determine whether the email message can be categorised as unsolicited and undesired email and/or email that has been sent with mischievous intent. This type of email message may be intended simply to annoy recipients or, more seriously, to introduce harmful software programs, for example a virus or Trojan program, into the user's computing device.

In this example, after an email message is checked by the filter 26, a content status character string indicative of the result of the filter check is inserted into the email header 14 of the email message.

A routing device 28, typically implemented by a software process, automatically allocates each email message to one of a plurality of folders 32 according to defined routing rules stored in a routing rules database 30. For example, a group of folders associated with different email types or email operations may be provided and the routing device 28 arranged to automatically allocate emails to the appropriate folder or to delete an email as appropriate. In one example, outgoing email desired to be sent to a recipient is automatically allocated to an outbox folder, and incoming email not identified as spam or malicious is automatically allocated to an inbox folder. In a further example, an email message identified as spam by the content status character string may be directed into a spam email folder. In a further example, the routing device 28 is arranged to forward emails meeting defined criteria, such as directed to a particular email address, to another email address. It will be understood that each user has a set of associated folders.

A content filter 31 connects to the mail server 20 through an after queue access port 33, the content filter performing any additional processing steps that might be required.

After passing through the content filter 31, the email messages are directed by the routing device 28 to the relevant folders 32 according to the defined routing rules stored in the routing rules database 30.

The email messages are retained in a user's inbox folder 32 at the mail server 20 until a mail client associated with the user accesses the mail server. When an authorised mail client accesses the mail server 20, email messages are extracted from the relevant folders 32 and sent to the mail client. The mail client is then subsequently controlled by a user to display the incoming email messages.

However, an increasing issue with conventional electronic message systems is the significant number of messages that each user typically receives every day. With an increasing number of automatically generated messages, it is not unusual for a person in an organisation to receive 200 or more emails every day. While some of these email messages may be important, many of the messages are not.

Automatic systems for classifying email messages as important or unimportant are known.

In one such system, the text contained in the message is analysed in order to automatically classify the relative importance of the message.

In another classification system, a mechanism is used wherein the actions of an email user are recorded and subsequently used to automatically classify the importance of emails. For example, if a user deletes an email without opening it to read the contents, this may indicate that subsequent messages from the same sender or with the same subject heading are of low importance.

However, such systems can be unreliable since they depend on the accuracy of the automatic classification aspects of the software.

It is known that most email users either check their incoming emails very frequently, for example every few minutes, and/or have configured an email client to provide an alert message whenever a new email message is received. Most of these users interrupt whatever they happen to be doing at the time to at least check the sender and the subject of the message that they have just received, and a majority open the message to read it immediately.

As a consequence, even if software is used to automatically classify the relative importance of the received emails, a significant amount of working time is still disrupted because of the tendency to immediately check emails as they arrive.

Many organisations have attempted to train their staff to adopt more efficient email practices that would at least reduce the negative effects on productive working time due to email disruptions, although to date most training interventions have not yielded sustained long term behaviour changes.

### SUMMARY OF THE INVENTION

In accordance with an aspect of the present invention, there is provided an electronic message management system comprising:
an electronic message server arranged to receive electronic messages addressed to a recipient user associated with the electronic message server, and to cause electronic messages to be sent from the electronic message server to an electronic message client associated with the user and arranged to display messages indicative of the electronic messages; and
a storage device arranged to store delivery rules;
the system being arranged to store electronic messages until the electronic messages are sent to an electronic message client;
each recipient user associated with the system having at least one associated delivery rule defining when electronic messages received by the message server are made available for sending by the message server to the message client associated with the recipient user; and
the system being arranged to apply the delivery rules to electronic messages received by the message server so as to control when the received electronic messages are made available for sending by the message server to the message client associated with the recipient user.

In one embodiment, the delivery rules define whether an electronic message is made available for sending by the message server immediately, or whether the electronic message is delayed from being made available for sending by the message server. When the electronic message is delayed from being made available for sending by the message server, the system may be arranged to make the electronic message available for sending by the message server at one or more defined times.

In one embodiment, the delivery rules define when electronic messages are made available for sending by the message server based on whether a recognisable key indicative of a defined priority level exists in the electronic message.

In one embodiment, the system is arranged to determine whether the key is present in a subject header portion of the electronic message.

The delivery rules may define when electronic messages are made available for sending by the message server based on an intended recipient of the electronic message.

The delivery rules may define when electronic messages are made available for sending by the message server based on the sender of the electronic message.

The delivery rules may define when electronic messages are made available for sending by the message server based on the text length of the electronic message.

In one embodiment, the system is arranged to allocate an inconvenience value to an electronic message based on an estimated degree of inconvenience likely to be caused by reading and/or responding to the electronic message.

In one embodiment, the system is arranged to allocate an inconvenience value to each one or more intended recipient of the electronic message.

In one embodiment, the system is arranged to display the inconvenience value to a message sender.

In one embodiment, the system is arranged to produce a total inconvenience value indicative of an estimated degree of inconvenience likely to be caused by reading and/or responding to all electronic messages received by recipients associated with an organisation.

In one embodiment, the inconvenience value is based on the level of seniority or cost of employing a person in an organisation.

In one embodiment, the inconvenience value is based on the text length of an electronic message.

In one embodiment, the system is arranged to make an electronic message available for sending by the message server when a processing tag is present in the electronic message.

In one embodiment, the system is arranged to add a processing tag to the electronic message when the electronic message has been processed according to the delivery rules.

In one embodiment, the system further comprises:
a primary electronic message server arranged to receive electronic messages from a sender; and
a secondary electronic message server in communication with the primary electronic message server;
the primary electronic message server arranged to send electronic messages to the secondary electronic message server when a processing tag is not present in the electronic message, and to make electronic messages available for sending by the message server when the processing tag is present in the electronic message; and
the secondary electronic message server arranged to add the processing tag to the electronic message and send the electronic message back to the primary electronic message server at defined times based on the delivery rules.

In one embodiment, the system is arranged to facilitate modification of the delivery rules by a user.

In one embodiment, the system is arranged to permit a user to determine whether any electronic messages have been received by the system but delivery of the or each electronic message has been delayed.

In one embodiment, the system is arranged to permit a user to cause all undelivered electronic messages that have been received for the user by the system to be delivered to the user.

In one embodiment, the electronic messages are email messages or SMS messages.

In accordance with a further aspect of the present invention, there is provided a method of managing electronic message delivery, the method comprising:
receiving at an electronic message server electronic messages addressed to a recipient user associated with the electronic message server;
causing electronic messages to be sent from the electronic message server to an electronic message client associated with the user and arranged to display messages indicative of the electronic messages;
storing delivery rules, each recipient user associated with the system having at least one associated delivery rule defining when electronic messages received by the message server are made available for sending by the message server to the message client associated with the recipient user;
storing electronic messages until the electronic messages are sent to an electronic message client; and
applying the delivery rules to electronic messages received by the message server so as to control when the received electronic messages are made available for sending by the message server to the message client associated with the recipient user.

### BRIEF DESCRIPTION OF THE DRAWINGS

The present invention will now be described, by way of example only, with reference to the accompanying drawings, in which:

FIG. 1 is a diagrammatic representation of a conventional email message structure;

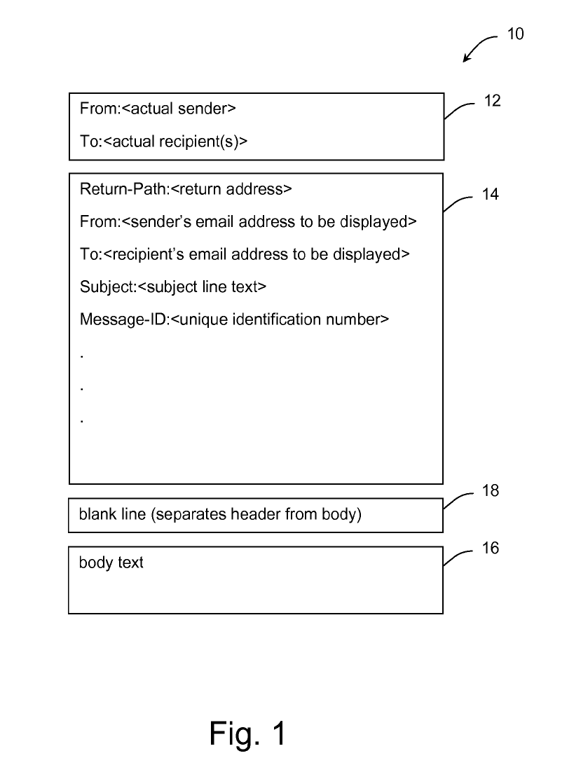

FIG. 2 is a diagrammatic representation of a conventional mail server;

FIG. 3 is a diagrammatic representation of an electronic message management system in accordance with an embodiment of the present invention; and

FIG. 4 is a diagrammatic representation of an example implementation of the electronic message management system shown in FIG. 3.

### DESCRIPTION OF AN EMBODIMENT OF THE INVENTION

The present system and method are arranged to reduce the extent to which incoming electronic messages interrupt a user and in so doing increase the user's productivity. In broad terms, this is achieved by arranging for delivery of at least some electronic messages to be delayed and instead to deliver the messages at defined times during the day. In this sense, the system and method resembles postal deliveries wherein batches of letters are delivered at approximately defined times.

At least one embodiment of the invention is also arranged to encourage users to send fewer electronic messages to fewer recipients. For this purpose, an inconvenience value referred to herein as email volume points (EVP), is used to crudely represent the degree of inconvenience likely to be caused by the time needed to read and respond to a particular email message.

The EVP value for each recipient may be calculated for example using an approximate measure of the amount of text that needs to be read, including attachments, multiplied by a factor that denotes the level of seniority of the recipient in the organisation.

An email message with a total EVP value that exceeds a defined threshold is not sent immediately. Instead, the message is held for a short time and the sender provided with an opportunity to reconsider whether the message should be sent. The sender can also be supplied with a brief explanation that assists the sender to understand why the message has been assigned a high EVP value.

The following embodiments are described in relation to an email messaging system, although it will be understood that the invention is also applicable to other electronic messaging systems such as short message service communication systems.

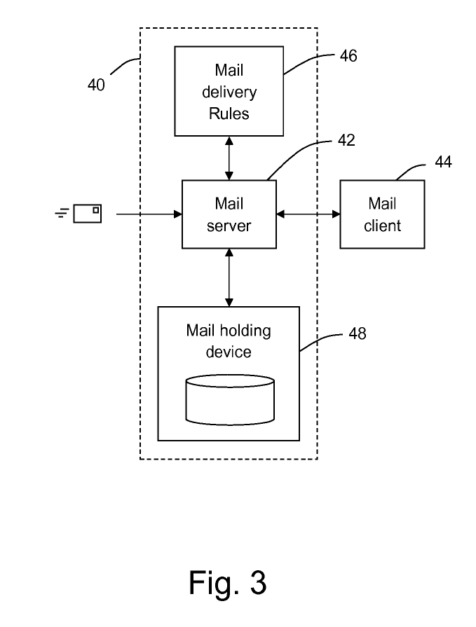

Referring to FIG. 3, a schematic diagram of an electronic message management system 40 is shown. In this example, the system is an email management system 40, although it will be understood that other electronic message management systems are envisaged.

The email management system 40 includes a mail server 42 arranged to receive email messages for users associated with the mail server 42 and send email messages on behalf of users associated with the mail server 42.

The mail server 42 communicates with a mail client 44 arranged to facilitate creation of mail messages by a user and, under control of the user, arranged to display received email messages. The mail client 44 is typically a software application that is implemented by a user computing device that may comprise a personal computer, tablet computer, smartphone, or any other suitable user computing device.

The system 40 also includes mail delivery rules 46 usable by the mail server 42 to govern how incoming email messages are handled, and in particular when the incoming email messages are made available to the mail server for retrieval by the email client.

The mail delivery rules 46 define the types of email messages that must be sent without delay to a recipient and the types of email messages that can be delayed. Emails that are deemed to be relatively low priority are not made accessible by an email client and instead are stored in a mail holding device 48 until one or more defined times. At each of the defined times, the stored email messages are transferred from the mail holding device 48 back to the mail server 42 and made accessible by an email client, for example by diverting the mail messages to an inbox associated with the user at the mail server 42.

It will be understood that by appropriately defining the mail processing rules, the times at which emails are delivered to a user can be controlled without the need to modify the user's mail client.

The email management system shown schematically in FIG. 3 may be implemented in various ways. For example, a conventional mail server may be modified so as to divert incoming email messages that meet defined criteria to a mail holding device, or a secondary mail server may be added to a conventional primary mail server, with the secondary mail server arranged to intercept mail messages and prevent the mail messages from reaching an inbox of the primary mail server until a desired time.

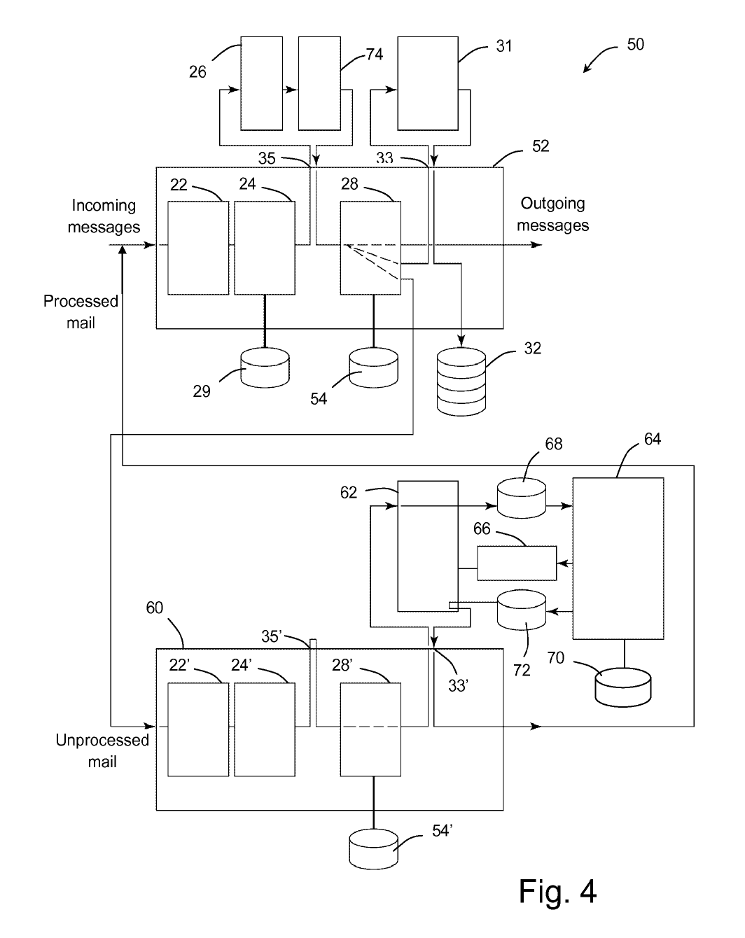

An example email management system 50 is shown in FIG. 4.

The system 50 includes a primary mail server 52, in this example Microsoft Exchange Server, although it will be understood that any suitable mail server of the type having customisable routing rules is envisaged. For example, a mail server based on Linux may be used as an alternative.

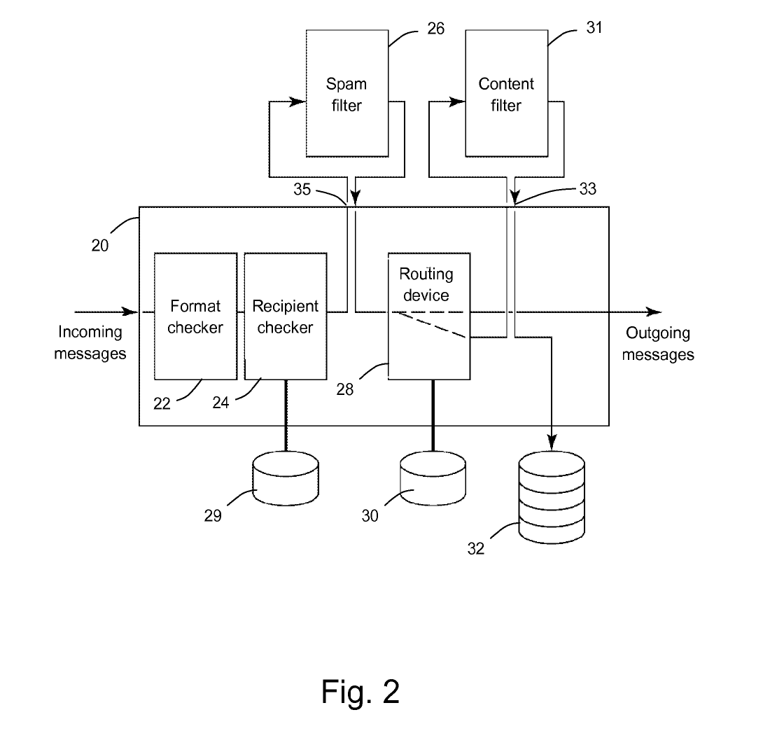

The primary mail server 52 in this example has similar functionality to the conventional mail server shown in FIG. 2. Like and similar features are indicated with like reference numerals.

As with the conventional mail server 20, when an email message addressed to a user is received at the primary mail server 52, a format checker 22 checks the format of the email message and makes a determination as to whether the format of the email message corresponds to a valid email message format, and a recipient checker 24 checks the address(es) of the recipients identified in the email message against recognised email addresses stored in an addresses database 29. If the email message format is not valid and/or a recipient address is not recognised, an automatic reply email is generated to indicate to the sender that the email message cannot be delivered.

As with the conventional mail server 10, a filter 26 scans the incoming email and a content status character string is added to the email header 14 to indicate whether the email can be categorised as spam and/or contains undesired content or code.

A routing device 28 automatically allocates incoming email messages to relevant folders 32 according to defined rules stored in a rules database 54. However, the rules in the rules database 54 are different to the rules stored in the rules database 30 of the conventional mail server 20 shown in FIG. 2 in that the rules are arranged to cause all incoming emails that have not already passed through the routing device 28 to be directed to a secondary mail server 60. At the secondary mail server 60, the email messages are analysed and either sent back to the primary mail server 52 and made available to an enquiring mail client for immediate delivery, or stored at the secondary mail server 60 and sent to the primary mail server 52 in batches at defined times. In this way, mail messages can be made available to an enquiring mail client at defined times so that mail messages are delivered to a user at defined times without the need to modify the mail client or the structure of the primary mail server 52.

As with the conventional mail server 20, the primary mail server 52 also includes a content filter 31 that performs additional processing steps that may be required by a particular organisation.

In the implementation shown in FIG. 4, the secondary mail server 60 includes similar components to the primary mail server 52 in that a format checker 22′, a recipient checker 24′, a routing device 28′, and a rules database 54′ are provided. However, the routing rules stored in the rules database 54′ are arranged to cause all incoming email messages to pass into a mail handler 62 arranged to receive mail from the secondary mail server 60, and store the mail in a mail storage device 68 for subsequent processing. The secondary mail server 60 is also associated with a mail prioritiser 64 arranged to receive mail from the mail storage device 68 and make determinations as to how and when the mail should be subsequently delivered to the recipients using defined criteria, in this example stored in a delivery instructions table 66.

Email that has been processed by the mail prioritiser 64 is provided by the mail prioritiser 64 with a processed tag, for example inserted into the email header 14. The processed tag may for example include the characters “X-MT-PROCESSED” and is used to indicate to the primary mail server 52 that mail has been processed by the secondary mail server 60 and has therefore been prioritised according to the defined criteria.

The secondary mail server 60 is configured to allow the mail handler 62 to connect to the after-queue access port 33′ of the secondary mail server 60. The secondary mail server 60 is also configured to receive mail only from the primary mail server 52 so that malicious attempts to send mail directly to the secondary mail server 60 can be prevented. In one embodiment, the secondary mail server 60 may be arranged to run on a computing device inside a firewall so that the secondary mail server 60 is not directly accessible from outside and can only be accessed through the primary mail server 52.

At initialisation, the mail handler 62 issues a request to the secondary mail server 60 to access the after-queue access port 33′ and receive all incoming email messages.

The mail handler 62 subsequently receives email messages through the after-queue access port 33′ and stores the messages in a mail storage device 68 that is accessible by the mail prioritiser 64. The mail handler 62 also functions to pass email messages back to the secondary mail server 60 when a determination is made that the messages are ready to be delivered.

The mail prioritiser 64 is arranged to regularly inspect the mail storage device 68 to see if there are any messages waiting to be processed. If there is a message waiting to be processed, the mail prioritiser 64 parses the message to identify components in the email header including the sender's email address, the recipients' email addresses, and the subject line text string; the body of the email message; and any attachments that are included with the message.

The mail prioritiser 64 also makes a determination as to whether the message should be delivered immediately to one or more of the identified recipients, or whether delivery of the message to one or more of the identified recipients can be delayed. In order to do this, the mail prioritiser 64 uses a set of delivery rules stored in a delivery rules database 70 to generate priority values for each message such that each recipient of an email message has an associated priority value for the message. Using the priority values, the mail prioritiser 64 generates a separate set of delivery instructions for each of the times at which a message needs to be delivered to a particular recipient or recipients.

The set of delivery rules use data stored in tables in the delivery rules database 70 to calculate the priority value for each message for each particular recipient. It will be understood that the calculated priority value associated with a particular message can be different for each of the designated recipients.

The priority value for each recipient is initially set to a default value, for example 0, and is then modified by adding a positive or negative value depending on the result of applying the delivery rules. However, it will be understood that any suitable arrangement is envisaged.

The term “priority” is used in relation to the description of the present embodiment as an internal measure of the importance of a message. In this example, priority is represented by a numerical value and, for a particular recipient, is derived from attributes of the email message and rules defined by the sender, each particular recipient, and/or an organisation with which the sender or receiver is associated.

The delivery rules database 70 includes a table referred to as “MailBox” that contains a list of email addresses of users associated with the system 50. Each record in the MailBox table includes at least the following parameters for each user associated with the system 50:
Email address;
Name;
Organisational group;
Standard email delivery times; that is the one or more times at which email messages with a moderate level of priority will be delivered during each working day;
Organisational time value level. This is a number between 1 and 10 that provides a measure of the relative importance of time to a person, with 10 being allocated to people whose time is the most valuable;
Priority delivery email address. This specifies an email address that can be used for the highest priority emails;
EVP threshold value. The EVP value is a crude measure of how time intensive reading the email message is likely to be for a receiver of the email. The EVP threshold value defines a threshold above which the email message will be delayed for a short time whilst the sender is warned about the likely time intensiveness of the email message, so that the sender can decide whether to continue to send the email;
Average expected email size for the user;
For information only string (FIO). This is a text string that indicates that subsequent text is included only for information and is not required to be read by the recipient.

The delivery rules database 70 also includes a default table that specifies default values for each of the parameters in the MailBox table. If any of the parameter values listed above is not defined, then the default value may be used instead.

The EVP value for a mail message may be calculated as follows.

The length of three different sections (L1, L2, L3) of the message is calculated by counting the number of printer characters, including space characters, as follows:

L1=message length before first occurrence of the sender's FIO string.

L2=message length after first occurrence of the sender's FIO string.

L3=combined size of attachments.

A reference value LQ is defined as log(EVPQ) divided by log(2), where EVPQ is a default message length in characters with a typical value of 200 characters. A function F(length) is defined as zero if the variable “length” is less than EVPQ, or else log(length)/log(2)−LQ.

The EVP value is calculated as follows:

EVP=F(L1)+0.3*F(L2)+0.1*F(L3)

In this way, a weighting is applied to the three sections of the message such that the message section L1 is most significant in calculating the EVP value, followed by the message section L2, and the message section L3 is least significant. However, it will be appreciated that any suitable mechanism for calculating an EVP type value is envisaged.

The total EVP value for an outgoing messages may be determined by multiplying the calculated EVP value by the sum total of the organisational time value parameters for all of the recipients, thus providing a measure of the total working time required for every recipient to read and respond to the message. The sum total of the organisational time value parameters for all of the recipients can optionally be modified depending on whether each recipient is on the carbon copy list of recipients or blind carbon copy list of recipients.

The system can keep records of the total EVP of all messages sent during a particular period by a particular user to inform users about the volume of mail they send, and also to help identify patterns of usage that might indicate excessive use of email. This type of information can be used to provide behavioural incentives for email users to reduce the volume of email and number of email messages sent to people.

The delivery rules database 70 also includes a table referred to as “DeliveryRule” that defines delivery rules that are applied in response to detection of an upper case character key string, for example in a subject line of the email message, or tagged by the message sender. In this example, each rule in the DeliveryRule table has four numerical parameters: PriorityAdj, EVPAdj, MinEVP, MaxEVP.

Examples of character key strings in this table include IMPORTANT and BULKEMAIL.

PriorityAdj is a numerical value indicative of the relative importance of the email message, and is used to modify the message priority value by adding the value of PriorityAdj.

A relatively high PriorityAdj value is specified when the character key string IMPORTANT is identified in an email message, for example +9. This results in a relatively high message priority value and therefore a higher likelihood that a message tagged IMPORTANT will be delivered immediately. A relatively low PriorityAdj value is specified when the character key string BULKEMAIL is identified in an email message, for example −9. This results in a relatively low message priority value and therefore a higher likelihood that a message tagged BULKEMAIL will not be sent immediately and instead will be delayed.

EVPAdj is a numerical value indicative of how time intensive reading the email message is likely to be for a receiver of the email. If the email message is tagged IMPORTANT, the total EVP value is modified by adding the value of EVPAdj to the total EVP value, for example +10. This results in a relatively high total EVP value and therefore a higher likelihood that a warning will be sent to the sender that the email exceeds the relevant EVP threshold value. This provides users with a strong incentive to keep important messages very short.

The parameters MinEVP and MaxEVP define upper and lower limits imposed on the modified EVP value. These parameters for example enable a message tagged BULKEMAIL to be given a low EVP value no matter how large it happens to be.

The calculated priority value for each message and/or recipient may be further adjusted by adding the value of a parameter CCAdj, usually −1, for each recipient on the carbon copy list, or by adding the value of a parameter BCCAdj, usually −3, for each recipient on the blind carbon copy list. This ensures that a negative weighting is applied to recipients included in an email message as CC or BCC that thereby decreases that likelihood that the recipient will receive the message immediately.

Finally, the mail prioritiser 64 checks whether email messages in the mail storage device 68 include a defined recipient or sender email address designated as high or low priority, or include a defined character key string in the subject line.

For example, a delivery rule may specify that all emails from the Chief Executive's email address have their associated message priority value increased by 10, thereby ensuring immediate delivery for every recipient.

In a further example, a delivery rule may specify that emails from a particular sender should have their associated message priority value decreased by 10, thereby making it likely that emails from the sender will be treated like bulk email.

In a further example, a delivery rule may specify that emails having a defined character string, for example “Xg4”, have their associated message priority value significantly increased to ensure immediate delivery for a recipient. In this way, a recipient can ensure that an email from a sender is received immediately by advising the sender to include a recipient specific character string, for example “Xg4”, in the subject line of the email.

The delivery rules database 70 also includes a table referred to as “DeliveryStrategy” that specifies which delivery option will apply to each recipient based on the priority value associated with the message and/or recipient. For example, the DeliveryStrategy table may define available deliveries as follows:

| Priority range | Delivery option |
|---|---|
| −9999 to 0 | Fridays at 11 am |
| 1 to 5 | Next standard delivery time |
| 5 to 10 | Next hour |
| 11 to 9999 | Immediate delivery |

After the delivery option for each recipient has been determined using the priority value for a message and/or recipient, the mail prioritiser 64 creates a delivery instruction for each email message and stores the delivery instruction in a delivery instructions table 66. It will be understood therefore that delivery instructions for each mail message are stored such that each email message is delivered to the relevant recipients at a time according to the relevant rules for the recipient defined by the parameters in the delivery rules database 70.

The delivery instructions table 66 and the delivery database 70 can be implemented using a common software component library such as MySQL, or in any other suitable way.

The mail prioritiser 64 also keeps a running total of the EVP values for email sent by each user over a defined time period. This allows email usage to be analysed in order to determine whether any users have exceptionally high EVP totals that may indicate that an exceptionally large amount of organisational time has been devoted to email originating from a particular user.

The mail prioritiser 64 may be arranged to regularly report total EVP for users with the highest EVP in the organisation. In this way, a reporting tool is provided to enable active management of email volume based on records of email use.

After the mail prioritiser 64 has processed an email message it modifies the message email header 14 so as to include a special text string <X-MT-PROCESSED>. The special text string is used to indicate to the first mail server 52 that the email message has been processed by the second mail server 60, and as a consequence should not be directed to the second mail server 60 by the routing device 28. Processed emails are stored in a mail holding device 72.

At regular time intervals, or when prompted to deliver a message immediately by the mail prioritiser 64, the mail handler 62 inspects the mail delivery instructions table in the database 66 to determine whether the table contains instructions to deliver an email message. When the delivery instructions table indicates that an email message is required to be delivered, the secondary mail server 60 immediately extracts the message from the mail holding device 72 and transmits the message to the primary mail server 52. The routing device 28 of the primary mail server 52 recognises the special text string in the email header and delivers the email message to the intended recipient(s) by storing the email message in a relevant folder 32, thereby enabling access to the email message by an email client.

After all recipients have received an email message, the mail handler 62 deletes the message from the mail holding folder 72.

It will be appreciated that since each email message and each recipient can have individual associated rules governing the desired priority level of email messages, it is possible that recipients of an email message will receive the email at different times.

The system 50 may be arranged such that an email sender known to the organisation has a degree of control over whether to delay sending of an email message according to defined rules or whether to send an email to a recipient immediately.

This may be achieved in several ways.

For example, the sender of the message may include a prearranged sequence of characters, a ‘text key’, in the subject line or body of the message, and the second mail server 60 arranged to recognise the text key, for example by specifying the text key in a rule in the DeliveryRule table described above.

Rules can define one or more such text keys for a group of users or an entire organisation. Normally, it would only be necessary for the individual user to send an email to a particular recipient with this key already in the subject line or body.

Alternatively, the text key could be conveyed by telephone or other means to selected prospective email senders.

Another way to achieve this would be to define a rule that would guarantee immediate delivery of an email message from a particular person in the organisation such as the Chief Executive or the personal assistant to the chief executive. This rule would recognise the email address of the sender of the message and associate this with the need to deliver the message immediately.

The delivery option can also be modified by calculating the attributes of an incoming message such that, for example, longer messages are more likely to be delayed and shorter messages are more likely to be delivered immediately.

Conventional email systems are arranged to allow a recipient to be nominated to receive a copy of a message. Common terms for this are CC—carbon copy—and BCC—blind carbon copy. The difference between CC and BCC is that for BCC the recipients of an email cannot see the email addresses of the BCC recipients.

Messages with BCC recipients require some additional special processing because both the primary and secondary mail server 52, 60 will suppress all of the BCC recipient email addresses and remove them from the email header.

In order enable appropriate processing of email messages with BCC recipients, the primary mail server 52 is arranged to communicate with a blind copy handling device 74, in this example implemented as a software process. The process is registered with the primary mail server 52, in this example Microsoft Exchange, as a “transport agent” in the form of a dynamically linked library module (DLL). The primary mail server can have several such agents registered, and each valid email message received by the mail server is passed to each of the agents for processing. The blind copy handling device 74 checks every incoming message and examines the “To:” list, the “CC:” list and the “BCC:” list. If the BCC list includes one or more email addresses associated with the email system 50, then the blind copy handling device 74 converts the BCC list to an encrypted BCC record in the email header 14. At the same time, the blind copy handling device 74 also expands any grouped recipient email address of local users into a list of the group member email addresses using the primary mail server authorised user database 29.

In this way, the information in the BCC list is retained, even though the BCC recipient list is removed from the email header 14 by the primary and secondary mail servers. The encrypted BCC record is recognised by the mail prioritiser 64 and the mail prioritiser 64 processes the email addresses in the same way as non-BCC email addresses in that appropriate delivery instructions are created for the email message for each of the BCC recipients that are associated with the system 10.

The system 10 may also be arranged to provide a subtle indication that there is mail waiting to be delivered at a later time, for example by providing a desktop client application associated with the mail prioritiser 64. This indication is designed to be much less prominent than typical alerts provided by existing mail clients, so that users normally do not notice it. When a user wishes to check for waiting mail, the user will notice a change in appearance of the desktop client icon, and can then open a small window to operate the desktop client.

Using the desktop client application, a user can request that all waiting messages be delivered immediately, for example if the user unexpectedly has time available in the day's schedule to deal with incoming email messages.

The desktop icon may also be arranged to change appearance if the user attempts to send a message with an EVP total value exceeding his or her threshold. An audible warning may also be generated. Using the desktop client, the user can cause the mail prioritiser 64 to delete the message. If the user takes no action, the mail prioritiser 64 may be arranged to send the message anyway after a short delay.

It will be appreciated that the desktop client could perform many other functions if desired, including providing access to a list of waiting email messages, and enabling a user to change the preferred delivery times and the rules that govern whether an email message is delayed or delivered immediately.

Depending on the way in which the desktop client communicates with the mail prioritiser 64, different levels of security protection can be provided within an organisation to prevent any possibility of external malicious attempts to subvert the operation of the system 10. For example, it is possible to arrange for the desktop client to operate only within the context of a virtual private network, a common arrangement used by organisations in which employees need to access protected parts of the relevant organisation intranet network from locations remote from the physical network.

It will be appreciated that the present system and method ensures that the timing of receipt of emails at an email client is controlled without the need to modify or change the email client with which a user is accustomed.

It will also be appreciated that since the timing of email delivery for each user and each message is determined by defined customisable rules, it is possible to enable designated users within an organisation or a community to receive most of their email at predetermined times, while other users remain entirely unaffected.

While the above embodiments relate to email communication, it will be understood that the invention is also applicable to other forms of electronic communication, such as short message service (SMS) communications familiar to mobile phone users.

Modifications and variations as would be apparent to a skilled addressee are deemed to be within the scope of the present invention.

1-42. (canceled)

43. An electronic message management system comprising:
an electronic message server arranged to receive electronic messages addressed to a recipient user associated with the electronic message server, and to cause electronic messages to be sent from the electronic message server to an electronic message client associated with the user and arranged to display messages indicative of the electronic messages; and
a storage device arranged to store delivery rules,
the system arranged to store electronic messages until the electronic messages are sent to an electronic message client,
each recipient user associated with the system having at least one associated delivery rule defining when electronic messages received by the message server are made available for sending by the message server to the message client associated with the recipient user, and
the system arranged to apply the delivery rules to electronic messages received by the message server so as to control when the received electronic messages are made available for sending by the message server to the message client associated with the recipient user.

44. A system as claimed in claim 43, wherein the delivery rules define whether an electronic message is made available for sending by the message server immediately, or whether the electronic message is delayed from being made available for sending by the message server.

45. A system as claimed in claim 44, wherein when the electronic message is delayed from being made available for sending by the message server, the system is arranged to make the electronic message available for sending by the message server at one or more defined times.

46. A system as claimed in claim 44, wherein the delivery rules define when electronic messages are made available for sending by the message server based on whether a recognisable key indicative of a defined priority level exists in the electronic message.

47. A system as claimed in claim 46, wherein the system is arranged to determine whether the key is present in a subject header portion of the electronic message.

48. A system as claimed in claim 44, wherein the delivery rules define when electronic messages are made available for sending by the message server based on at least one of an intended recipient of the electronic message, the sender of the electronic message, and the text length of the electronic message.

49. A system as claimed in claim 43, wherein the system is arranged to allocate an inconvenience value to an electronic message based on an estimated degree of inconvenience likely to be caused by at least one of reading and responding to the electronic message.

50. A system as claimed in claim 49, wherein the system is arranged to allocate an inconvenience value to each one or more intended recipient of the electronic message.

51. A system as claimed in claim 49, wherein the system is arranged to display the inconvenience value to a message sender.

52. A system as claimed in claim 49, wherein the system is arranged to produce a total inconvenience value indicative of an estimated degree of inconvenience likely to be caused by at least one of reading and responding to all electronic messages received by recipients associated with an organisation.

53. A system as claimed in claim 49, wherein the inconvenience value is based on at least one of the level of seniority, cost of employing a person in an organisation, and the text length of an electronic message.

54. A system as claimed in claim 43, wherein the system is arranged to make an electronic message available for sending by the message server when a processing tag is present in the electronic message, the processing tag added to the electronic message when the electronic message has been processed according to the delivery rules.

55. A system as claimed in claim 54, comprising:
a primary electronic message server arranged to receive electronic messages from a sender; and
a secondary electronic message server in communication with the primary electronic message server,
the primary electronic message server arranged to send electronic messages to the secondary electronic message server when a processing tag is not present in the electronic message, and to make electronic messages available for sending by the primary electronic message server when the processing tag is present in the electronic message, and
the secondary electronic message server arranged to add the processing tag to the electronic message and send the electronic message back to the primary electronic message server at defined times based on the delivery rules.

56. A system as claimed in claim 43, wherein the system is arranged to facilitate modification of the delivery rules by a user.

57. A system as claimed in claim 43, wherein the system is arranged to permit a user to determine whether any electronic messages have been received by the system but delivery of the electronic message or each electronic message has been delayed.

58. A system as claimed in claim 43, wherein the system is arranged to permit a user to cause one or more of the undelivered electronic messages that have been received for the user by the system to be delivered to the user.

59. A system as claimed in claim 43, wherein the electronic messages are email messages or SMS messages.

60. A method of managing electronic message delivery, the method comprising:
receiving at an electronic message server electronic messages addressed to a recipient user associated with the electronic message server;
causing electronic messages to be sent from the electronic message server to an electronic message client associated with the user and arranged to display messages indicative of the electronic messages;
storing delivery rules, each recipient user associated with the system having at least one associated delivery rule defining when electronic messages received by the message server are made available for sending by the message server to the message client associated with the recipient user;
storing electronic messages until the electronic messages are sent to an electronic message client; and
applying the delivery rules to electronic messages received by the message server so as to control when the received electronic messages are made available for sending by the message server to the message client associated with the recipient user.

61. A method as claimed in claim 60, wherein the delivery rules define whether an electronic message is made available for sending by the message server immediately, or whether the electronic message is delayed from being made available for sending by the message server.

62. A method as claimed in claim 61, wherein when the electronic message is delayed from being made available for sending by the message server, the method comprises making the electronic message available for sending by the message server at one or more defined times.

63. A method as claimed in claim 61, wherein the delivery rules define when electronic messages are made available for sending by the message server based on whether a recognisable key indicative of a defined priority level exists in the electronic message.

64. A method as claimed in claim 61, wherein the delivery rules define when electronic messages are made available for sending by the message server based on at least one of an intended recipient of the electronic message, the sender of the electronic message, and the text length of the electronic message.

65. A method as claimed in claim 60, comprising allocating an inconvenience value to an electronic message based on an estimated degree of inconvenience likely to be caused by at least one of reading and responding to the electronic message.

66. A method as claimed in claim 65, comprising allocating an inconvenience value to each one or more intended recipient of the electronic message.

67. A method as claimed in claim 65, comprising displaying the inconvenience value to a message sender.

68. A method as claimed in claim 65, comprising producing a total inconvenience value indicative of an estimated degree of inconvenience likely to be caused by at least one of reading and responding to all electronic messages received by recipients associated with an organisation.

69. A method as claimed in claim 65, wherein the inconvenience value is based on at least one of the level of seniority, cost of employing a person in an organisation, and the text length of an electronic message.

70. A method as claimed in claim 60, comprising adding a processing tag to the electronic message when the electronic message has been processed according to the delivery rules, and making an electronic message available for sending by the message server when a processing tag is present in the electronic message.

71. A method as claimed in claim 70, comprising:
providing a primary electronic message server arranged to receive electronic messages from a sender;
providing a secondary electronic message server in communication with the primary electronic message server;
sending electronic messages from the primary electronic message server to the secondary electronic message server when a processing tag is not present in the electronic message;
making electronic messages available for sending by the primary electronic message server when the processing tag is present in the electronic message;
at the secondary electronic message server, adding the processing tag to the electronic message; and
sending the electronic message from the secondary electronic message server to the primary electronic message server at defined times based on the delivery rules.
